(19) United States
(12) Patent Application Publication
(10) Pub. No.: US 2007/0241120 A1
(43) Pub. Date: Oct. 18, 2007

(54) Vending machine having a video display and method of advertising

(76) Inventor: Mark A. Henry, Virginia Beach, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 11/786,705

(22) Filed: Apr. 12, 2007

Related U.S. Application Data
(60) Provisional application No. 60/791,559, filed on Apr. 12, 2006.

(51) Int. Cl. G07F 11/00

(52) U.S. Cl. 221/2; 221/8

(57) ABSTRACT

A soda dispensing machine that includes a dynamic advertising medium that includes a memory coupled to a microprocessor which controls an audio generating device and a video displaying means. The audio generating device is coupled to a speaker that emits an advertising message. The programmable memory is coupled to a connector for updating the memory of the dynamic advertising medium. The memory may be re-programmable in a variety of ways. The video displaying means displays both a static advertising image and a dynamic advertising message. The audio generating device and the video displaying means are actuated by a switch or a plurality of switches wired in parallel in a variety of manners.

The present invention claims priority from U.S. provisional patent application Ser. No. 60/791,559 which was filed on Apr. 12, 2006.

This patent application did not receive federal research and development funding.

### TECHNICAL FIELD

The present invention generally relates to vending machines that can display advertising messages including filmed or animated television commercials on a display screen. The vending machine may include a liquid, ice or combination of liquid and ice dispensing machine coupled to a dynamic advertising medium. More specifically, the present invention is a soda machine that includes a cover, a memory, at least one speaker and a video display mechanism mounted in or on the cover. Preferably, the display screen is provided in or on a front face of the soda machine that faces a user. Actuation switches, such as pressure actuated triggers, are arranged below the display mechanism for dispensing soda mixtures or other types of snacks. A method is also disclosed for advertising wherein a static image is first displayed. When an actuation switch is activated, the static image is replaced by a streaming video that is synchronized with the speaker to emit an audible message.

It is understood that the term vending machine may include a vending machine that dispenses snacks other than soda. Throughout this disclosure the term “soda” is used. This term should be interpreted broadly to include any type of liquid or ice.

### BACKGROUND OF THE INVENTION

Vending machines and soda dispensing machines are found in a variety of settings such as fast food restaurants, food marts, gas stations, convenience stores and other modern settings. Many vending machines that dispense bottles or cans of soda include a plastic cover having a portion thereof that displays a static image such as a large soda. The image may be lit by lights or the like that are arranged behind the image.

A typical soda machine includes a plurality of hoses that connect between a first container storing syrup and a second container storing carbonated water. The syrup and carbonated water are mixed at a dispensing point on a front of the soda dispensing machine that faces an operator. A pressure activated trigger is arranged below the dispensing point and upon activation, causes an appropriate amount of syrup and carbonated water to be mixed together. A drain is arranged below the dispensing point at a predetermined distance and includes a grate upon which a cup or other container may be rested during the soda dispensing process.

### SUMMARY OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

The present application is a vending or soda dispensing machine that comprises a dynamic advertising medium comprising a reprogrammable memory coupled to a microprocessor that controls an audio generating device and a video displaying means. The audio generating device comprises one or more speakers located in the dynamic advertising medium or remote therefrom and at least operable when an advertisement is accessed from a database having streaming video stored therein for display on the video display means.

The dynamic advertising medium includes a reprogrammable memory coupled to a connector or connection point for updating the memory of the dynamic advertising medium. The memory may be programmable in a variety of manners, including connection points for coupling the memory to an off-board controller that controls the actions of the dynamic advertising medium through use of a mobile memory storage device. The mobile memory storage device may include, but is not limited to, thumb drives, discs or other memory storage means that may be inserted into or easily coupled to the dynamic advertising medium for reprogramming advertising operations of the machine. The memory may otherwise be updated through the use of connection points that comprise the Internet, telephone communications or satellite transmissions. A first storage database in the memory or a first memory stores fixed images in known formats such as JPEG, TIFF, Bit-map, GIF or PDF. A second storage database or a second memory stores streaming videos in a variety of formats including, but not limited to, windows media, real media, quick-time, flash, and MPEG-4. In this manner, the soda or vending machine may thereby display a downloadable advertising message that includes fixed or static images and dynamic images that create a video. The memory may be in a looped form such that when a last stored static image or last stored streaming video is displayed, the first stored static image or first stored streaming video is displayed. In this manner, an advertising loop may be created to assure an advertiser that his advertisement will at a minimum be viewed as often as any other user. Pointers may also be implemented in either the first or second storage database for tracking the next advertisement to be displayed.

The stored advertising includes messages that display a static advertising image such as a corporate logo for a fixed period of time. Upon activation of a switch, the advertising message being displayed changes from a static advertising message to a dynamic advertising message that includes a streaming video signal and having a sequenced audio signal provided to the audio generating device. The streaming video comprises an advertising message such as a video of a person drinking a soda dispensed from a similar vending or soda dispensing machine as the instant invention and is only displayed for a time necessary to fill a cup with soda or for a soda or other snack to be retrieved from a retrieval area in the vending machine. Other video messages may show a person using other products sold in the store where the soda dispensing machine is located. The machine capitalizes on impulse buying habits of the consuming public by stimulating both their visual and auditory senses. Activation or actuation of the switch is caused by a customer triggering an event such as dispensing soda from a soda machine, depositing coins or bills into a vending machine, or pressing a button on the vending machine. Thus, the invention has great utility in the advertising world.

The streaming video is displayed when the switch is activated. The switch may include motion detector circuitry, infrared transceiver sets, or a normally open spring-loaded switch arranged behind a liquid or ice dispensing trigger or a switch coupled to a push button that causes a snack or soda to be dispensed from a vending machine. Alternatively, a normally closed spring-loaded switch arranged in front of the dispensing trigger may be utilized as a switching means for causing a display to switch from a static to dynamic message in a soda dispensing machine. It should be recognized that many other types of switches may be utilized for activating the streaming video. Activating the switch causes the display to switch between static and dynamic messages. A motion detector switch may be utilized to market to customers that are near the vending machine but not utilizing it.

A method for accomplishing the invention is disclosed hereinafter. The method includes providing all of the necessary parts including a vending machine or soda dispensing machine comprising a video display screen and speaker system to create a dynamic advertising medium. A reprogrammable memory is coupled to a microprocessor to control an audio generating device or driver and a video displaying means. The reprogrammable memory is also coupled to a connector or connection point for updating the memory of the dynamic advertising medium. The memory may be programmable in a variety of manners or updated as mentioned above to display a downloadable advertising message that includes both fixed images and moving images.

The downloadable advertising includes messages that display a static advertising image and upon activation of a switch, the advertising message being displayed changes from the static advertising image to a dynamic advertising message that includes a streaming video signal and having a sequenced audible signal. The streaming video may be of the type mentioned above. The switch may be of the type mentioned above.

A static image is displayed on the video display screen for a fixed period of time, subject to activation of the switch. A different static image is displayed after the fixed period of time expires if the switch has not been activated. This continues until the last static image is displayed unless the switch is otherwise activated.

If the switch is activated, then the dynamic memory that stores the streaming video is accessed causing a video to be displayed on the video screen and simultaneously broadcasting an audible message through the speakers.

Thus, the method further includes determining the state of the switch to cause either a static or dynamic advertising message to be displayed on a display screen mounted in or on a vending or soda dispensing machine.

It is an object of the invention to disclose a vending or soda dispensing machine having a display coupled to a microprocessor that includes a memory for storing both static and dynamic advertising messages therein.

It is another object of the invention to teach a method of advertising using a soda dispensing machine that includes a display mounted thereon. A microprocessor coupled to the display is housed within a cover that houses the soda dispensing machine.

It is another object of the invention to provide an improved vending machine system that includes a dynamic advertising medium including a display and speakers for conveying an advertising message to a consumer.

The above and further objects, details and advantages of the invention will become apparent from the following detailed description, when read in conjunction with the accompanying drawings.

### BRIEF DESCRIPTION OF THE DRAWINGS

FIG. 1 is a perspective view of a first embodiment of the present invention.

FIG. 2 is a frontal view of the first embodiment of the invention.

FIG. 3 is a block diagram of the first embodiment of the invention.

FIG. 4 is an operational flowchart of the first embodiment of the invention.

FIG. 5 is a perspective view of a second embodiment of the invention.

FIG. 6 is a schematic view of a network of vending machines coupled to a remote central controller that wirelessly transmits advertising messages to be stored in a memory of each vending machine.

FIG. 7A is a schematic view of a memory for use in the present invention. FIG. 7B is a schematic view representing a database for storing static images and an associated pointer. FIG. 7C is a schematic view representing a database for storing dynamic images such as streaming video and its associated audio.

### DETAILED DESCRIPTION OF THE INVENTION

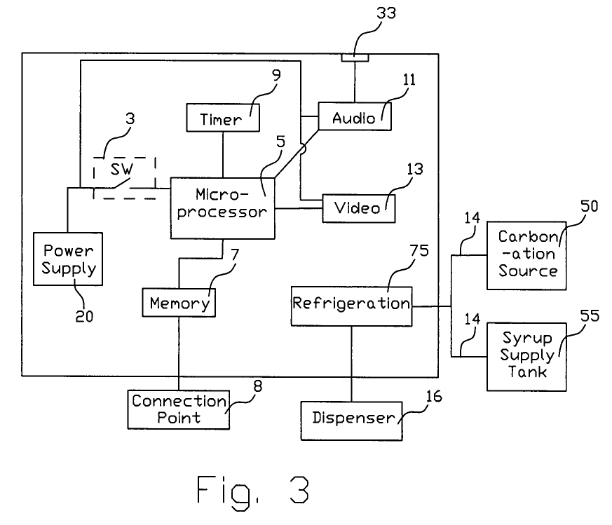

In a first preferred embodiment, a soda machine 1 includes a plurality of triggers 80 that activate a dispensing operation. A plurality of switches, collectively represented as element 3 in FIG. 3 is arranged such that an individual switch is coupled to a corresponding trigger 80. These switches are wired in parallel such that when any one is activated, an actuation signal is fed into the microprocessor 5. Thus when any one of the triggers 80 is used to dispense soda, a signal causes the microprocessor 5 to activate a dynamic advertising display message. Otherwise the soda machine 1 or vending machine 55 may include a motion detection switch or an infrared transceiver set arranged at opposite ends of a drain that is arranged below the plurality of triggers such that when a cup is rested on the drain, the dynamic advertising will be displayed on the display screen 13.

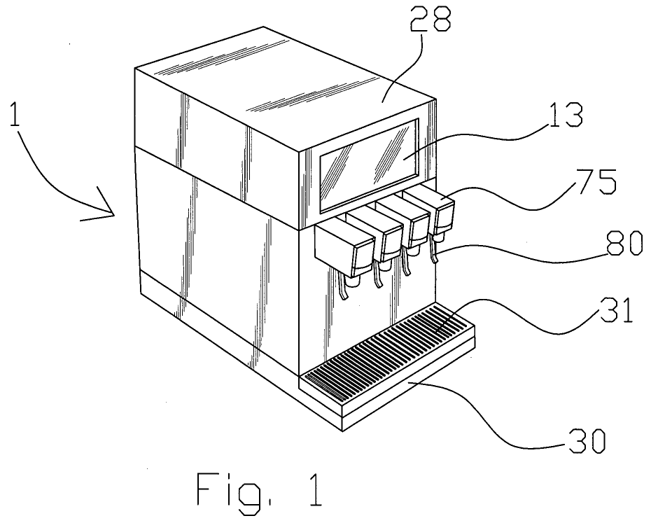

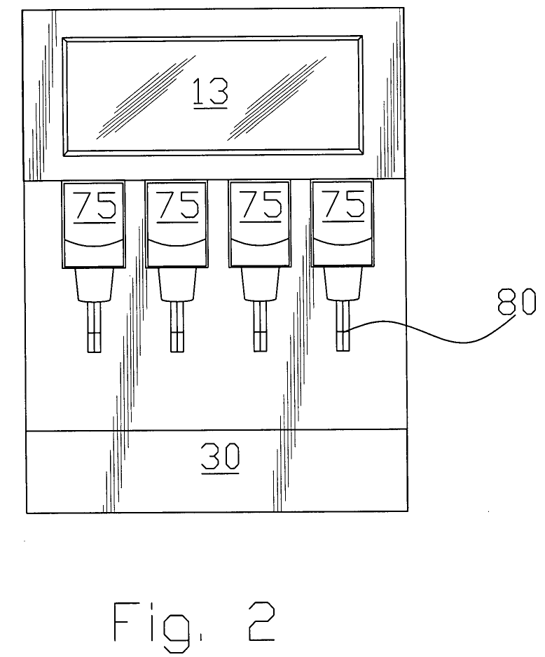

As can be seen in FIGS. 1 and 2, the soda machine 1 includes a video display 13 that is arranged above soda dispensing points 75. The video display 13 is fixed within the soda machine cover 28 and initially displays a static advertising message. Upon activation of switch 3, the displayed advertising message changes from a static message to a dynamic message that includes streaming video.

Each soda dispensing point 75 includes a pressure activated trigger 80. A user arranges a cup below a dispensing point 75 and pushes a sidewall of the cup against the trigger 80 to cause soda to be dispensed into the cup. Any overflow of soda drops through grate 31 and into a drain area 30.

FIG. 3 shows a block diagram of the soda machine 1. A power supply 20 is connected to the switch 3 that is connected to an input of a microprocessor 5 that includes or is coupled to a memory 7 which is periodically re-programmed through a connection point 8, as mentioned above. A timer 9 is included in the microprocessor 5 or attached thereto for providing a clock that is monitored to determine a period of time of operation of a particular static advertisement that is being displayed on the display screen.

The memory 7 stores various static and dynamic advertising messages and is accessed by the microprocessor 5 that controls outputs to audio emitter 11 and/or video means 13.

As shown, the machine 1 is coupled to a carbonation source 50 and a syrup supply tank 55. Hoses 14 route syrup and carbonation liquids through a refrigeration unit 75 for cooling both. The hoses 14 connect to the dispenser 16 which combines them together in an appropriate amount.

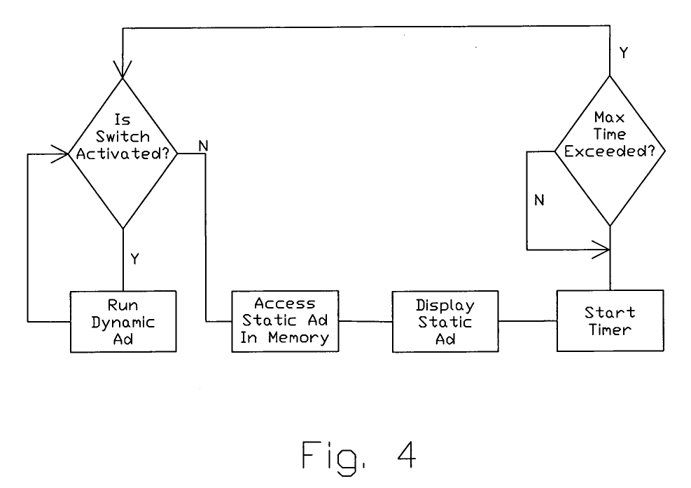

FIG. 4 is an operation flowchart for the present invention. In a first step, the microprocessor 5 determines the state of switch 3. If the switch is not activated, the memory 7 is accessed and a stored static message is displayed on the display 13 for a predetermined period of time. Periodically, the microprocessor 5 checks the switch 3 to determine its state. Upon activation of the switch, the microprocessor accesses a dynamic advertising message which may include several animated images or streaming video and audio advertisement commercials. Each advertisement is played from a beginning to an end. If the switch 3 continues to be activated, a next-in-line dynamic advertising message is displayed. This action continues until all dynamic advertising messages have been displayed. Thereafter, the dynamic advertising messages are displayed in the same order to create a loop of advertisements. Music may be played through the speaker when a static advertisement is displayed. If the switch 3 is in a non-operational state, static messages continue to be displayed for predetermined periods of time in a looping manner as mentioned above with respect to the dynamic advertising. The length of the loop may a desirable time up to twenty four hours.

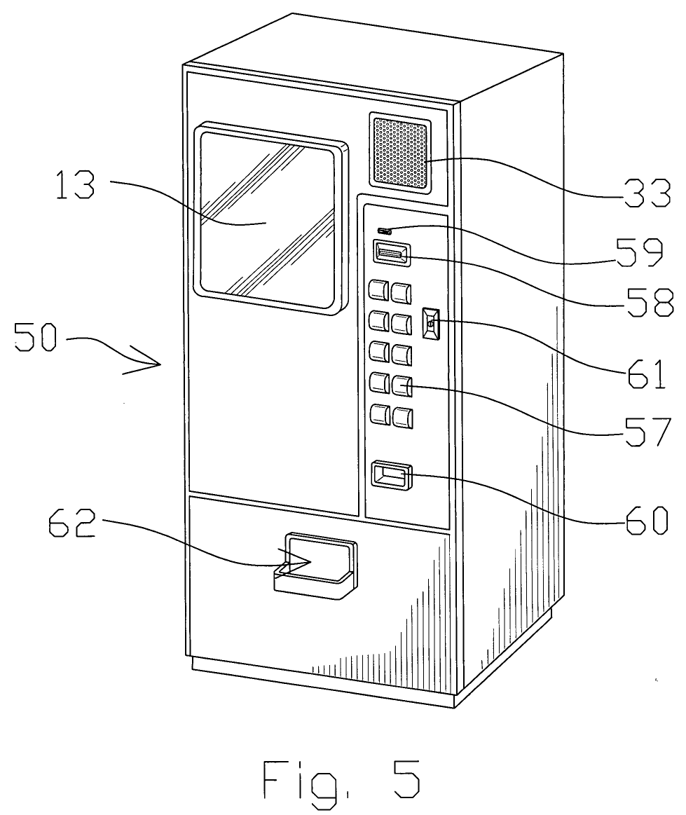

FIG. 5 shows a vending machine 50 that dispenses soda from cans or bottles. A video display screen 13 is arranged on a front of cover 55. A speaker 33 is also arranged within the cover 55. A lock 61 is included on a front of the cover for gaining access to restock the inventory of bottles or cans within the vending machine 50, as well as to collect money. In this type of vending machine, coins are deposited into the coin slot 59 or dollars are inserted through dollar changing 58. The customer then selects a desired drink and pushes a corresponding button 57. A bottle or can of soda is dispensed from the machine through the retrieval opening 62. Any change due the consumer is returned through change opening 60. This type of vending machine includes the dynamic advertising medium as mentioned above. Thus, the video display 13 and speaker 33 operate in the same manner as mentioned previously. Otherwise, a switch may be connected to the coin slot or dollar changer for changing the display screen from one advertisement to another. Otherwise, an output, from the push button that is pushed to obtain a soda or snack, may trigger a change in the advertisement displayed on the display screen.

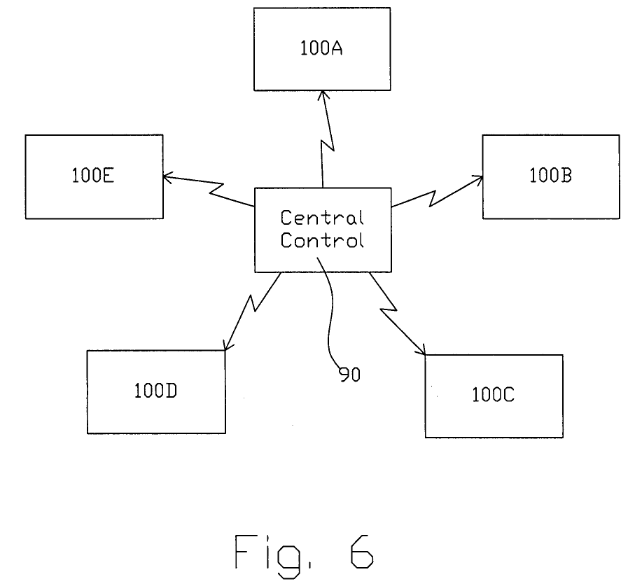

FIG. 6 depicts a network of convenience stores 100A-E that each includes an individually addressable soda dispensing or vending machine. A central controller 90 is operated to wirelessly upload advertisements to each soda dispensing or vending machine. In this manner, the advertising content of a plurality of soda dispensing or vending machines may be easily controlled.

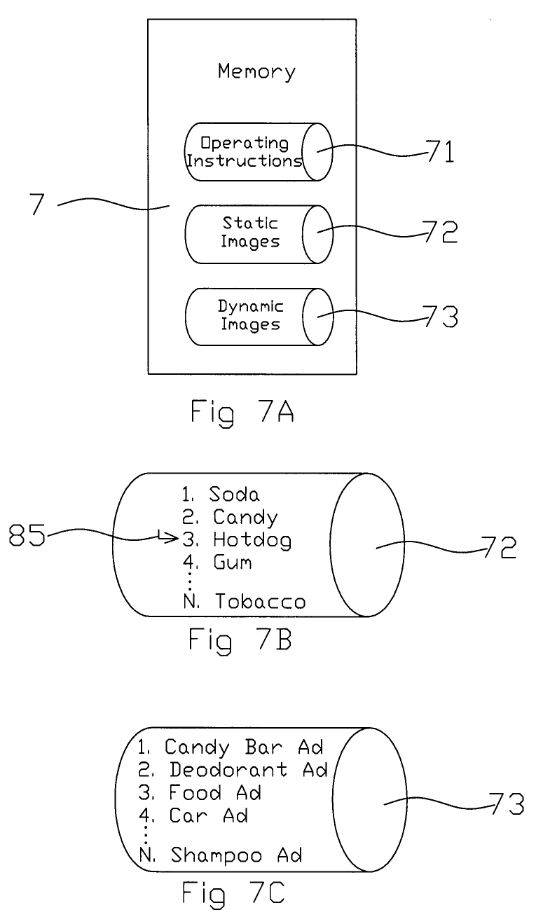

FIG. 7A represents a preferred structure for memory 7 for operating the vending or soda dispensing machine. Memory 7 includes a database of operating instructions 71 for controlling operation of the microprocessor 5. Another database 72 stores the static images that are displayed on the display 13. A further database 73 stores the dynamic images and any associate data that controls the audio generating device 11.

As represented by FIG. 7B, the static image database 72 may be controlled through use a pointer 85 that tracks the next advertisement to be displayed. When the last static or dynamic image, represented as “N. Tobacco” is displayed, the pointer 85 is reset to “1. Soda”. This process creates a loop of advertising material. A software implemented pointer may also be used in the dynamic image database to track advertisements already played.

As represented by FIG. 7C, the dynamic image database may be configured such that when the switch 3 is activated, all of the dynamic images are displayed. Should the switch remain active until the last dynamic advertisement, represented here as “N. Shampoo Ad”, is displayed, the first dynamic advertisement will begin playing following the conclusion of the last dynamic advertisement.

A vending or soda machine as in the present invention may be equipped with the microprocessor, audio emitter and video display as an all-in-one unit such as a flat panel computer that comprises a combination microprocessor and flat panel display. An example of such type of computer is the DisplayPac-OP industrial computer, sold by Computer Dynamics of Greenville S.C. This computer features a choice of computing engines up to 2.8 GHz. The display may come in a variety of sizes choice of display sizes and includes an active matrix TFT LCD. It may comprise a touch screen and include a hard drive, floppy drive, CD-ROM or other type of memory storage device. The computer may include PCI expansion slots and an internal power supply. All may be provided in a heavy-duty steel enclosure. Other features may include an LCD display screen, a CPU, memory, an integrated VGA/LCD controller, an Ethernet connection point, serial and parallel ports, a mouse input, an RS-232/485 input, a digital I/O connection point, other input and output points such as a RJ-12 phone jack, USB and VGA ports, a power supply, a hard drive, a CD-ROM drive and a floppy drive.

Other computerized displays that may be suitable for use in the present invention include an Industrial Panel PC sold by Aplex of 2600 Boyce Plaza Road, Pittsburgh, Pa. and Display Monitors and Model ADP-1151 also sold by Aplex. Another suitable display is the FPI Series LCD Display sold by Nortech Engineering of 15 Commerce Way, Norton Mass. This display is a thin film transistor, (TFT) LCD display and are XGA LCDs and SXGA LCDs.

An example of the soda dispensing machines that may be used may be one of those sold under models MD-150, MD-200, MD-250, MDH-302, MDH-402 by Manitowoc of Sellersburg Ind. These include automatic ice crushers that include an ice maker/ice dispenser combination along with a plurality of beverage dispenser points.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

1. A vending machine having an inventory of soda or snacks, said vending machine comprising:
a video display screen for displaying static, dynamic and animated advertisements;
a sound generating device coupled to at least one speaker and causing sound to be emitted from the at least one speaker when a dynamic or animated advertisement is displayed on the video display screen;
a microprocessor that controls the video display screen and the sound generating device;
a reprogrammable memory connected to the microprocessor, said reprogrammable memory comprises a database having operating instructions, a database of static advertisements, and a database of animated or dynamic advertisements;
at least one switch connected to said microprocessor for activating a dynamic or animated advertisement; and,
a power source that supplies power to the video display screen, the sound generating device, and the microprocessor.

2. The vending machine of claim 1 wherein said vending machine is a soda dispensing machine that dispenses soda into cups and includes a plurality of triggers that are actuated by pushing a cup against one of triggers, the at least one switch is a plurality of switches, each switch coupled to a single trigger of the soda dispensing machine and being wired in parallel with the other switches in the plurality of switches.

3. The vending machine of claim 1 wherein said vending machine dispenses sodas that are sold in cans or bottles and includes a lock for restricting access to an interior of the vending machine and a retrieval opening for retrieving cans or bottles of soda that have been purchased by a customer, said vending machine further including a change opening for accepting coins and a dollar bill opening for accepting dollar bills and the at least one switch is a plurality of switches, each switch coupled to a single push button that corresponds to a particular soda and being wired in parallel with the other switches in the plurality of switches.

4. The vending machine of claim 1 wherein the at least one switch is selected from a group consisting of motion detector circuitry, infrared transceiver sets, a normally open spring-loaded switch and a normally closed spring-loaded switch

5. The vending machine of claim 1 further comprising a mobile memory storage device selected from a group consisting of thumb drives, magnetic discs, floppy discs, and other memory storage means that may be inserted into or easily coupled to the vending machine for reprogramming advertising operations of the vending machine.

6. The vending machine of claim 1 wherein the memory includes a connection means selected from one consisting of the Internet, telephone communications and satellite transmissions.

7. The vending machine of claim 1 wherein the reprogrammable memory includes a first database that stores fixed images in a image format selected from a group consisting of JPEG, TIFF, Bit-map, GIF or PDF files

8. The vending machine of claim 1 wherein the reprogrammable member includes a storage database that stores streaming videos in a format selected from a group consisting of windows media, real media, quick-time, flash, and MPEG-4.

9. A vending machine having an inventory of soda or snacks, said vending machine comprising:
a video display screen for displaying static, dynamic and animated advertisements;
a sound generating device coupled to at least one speaker and causing sound to be emitted from the at least one speaker at least when a dynamic or animated advertisement is displayed on the video display screen;
a microprocessor that controls the video display screen and the sound generating device;
a reprogrammable memory coupled to the microprocessor, said reprogrammable memory comprises a database having operating instructions, a database of static advertisements and a database of animated or dynamic advertisements;
at least one switch connected to said microprocessor for activating a dynamic or animated advertisement;
a power source that supplies power to the video display screen, the sound generating device, and the microprocessor; and,
a software process written into the operating instructions that control the microprocessor, said software process causing advertisements to occur in a loop such that when the last advertisement is displayed then the next displayed advertisement is the first advertisement.

10. The vending machine of claim 9 wherein said vending machine is a soda dispensing machine that dispenses soda into cups and includes a plurality of triggers that are actuated by pushing a cup against one of triggers, the at least one switch is a plurality of switches, each switch coupled to a single trigger of the soda dispensing machine and being wired in parallel with the other switches in the plurality of switches.

11. The vending machine of claim 9 wherein said vending machine dispenses sodas that are sold in cans or bottles and includes a lock for restricting access to an interior of the vending machine and a retrieval opening for retrieving cans or bottles of soda that have been purchased by a customer, said vending machine further including a change opening for accepting coins and a dollar bill opening for accepting dollar bills and the at least one switch is a plurality of switches, each switch coupled to a single push button that corresponds to a particular soda and being wired in parallel with the other switches in the plurality of switches.

12. The vending machine of claim 9 wherein the at least one switch is selected from a group consisting of motion detector circuitry, infrared transceiver sets, a normally open spring-loaded switch and a normally closed spring-loaded switch

13. The vending machine of claim 9 further comprising a mobile memory storage device selected from a group consisting of thumb drives, magnetic discs, floppy discs, and other memory storage means that may be inserted into or easily coupled to the vending machine for reprogramming advertising operations of the vending machine.

14. The vending machine of claim 9 wherein the memory includes a connection means selected from one consisting of the Internet, telephone communications and satellite transmissions.

15. The vending machine of claim 9 wherein the reprogrammable memory includes a first database that stores fixed images in a image format selected from a group consisting of JPEG, TIFF, Bit-map, GIF or PDF files

16. The vending machine of claim 9 wherein the reprogrammable member includes a storage database that stores streaming videos in a format selected from a group consisting of windows media, real media, quick-time, flash, and MPEG-4.

17. A method of supplying a snack or soda to a customer while simultaneously advertising to the customer, said method comprising:
providing a vending machine that includes a video display screen and audio generating device having a microprocessor coupled to the reprogrammable memory to control the audio generating device and a video displaying means, said vending machine also comprising a switch connected to the microprocessor to change an advertisement being displayed on the video display screen; and,
streaming advertisements across the video display screen.

18. The method of claim 17 further comprising:
displaying a first static advertisement that is stored in the reprogrammable memory on the video display screen for a fixed period of time; and,
changing the first static advertisement to a second static advertisement when the fixed period of time has expired if the switch has not been activated.

19. The method of claim 18 wherein when said customer activates the switch on the vending machine, a dynamic advertisement is displayed on the video display and sound is emitted from the audio generating device.
